(19) United States
(12) Patent Application Publication
(10) Pub. No.: US 2006/0151896 A1
(43) Pub. Date: Jul. 13, 2006

(54) Method of centrifugally generating ozonated water and system thereof

(76) Inventor: Wen Wang, Taipei (TW)

Correspondence Address: BRUCE H. TROXELL, SUITE 1404, 5205 LEESBURG PIKE, FALLS CHURCH, VA, 22041, US

(21) Appl. No.: 11/217,504

(22) Filed: Sep. 2, 2005

(30) Foreign Application Priority Data
Jan. 7, 2005 (TW) 094100573

(51) Int. Cl. B01F 3/04

(52) U.S. Cl. 261/89; 210/760; 261/DIG. 42

(57) ABSTRACT

In a system including a centrifugal ozonated water generator, a centrifugal drive source for rotating the ozonated water generator, a liquid source for supplying water to the ozonated water generator, an ozone gas generator fluidly connected to the ozonated water generator, an ozonated water drain regulator, and a sensing assembly for monitoring ozone gas concentration, a method comprises supplying water to an ozonated water generator, supplying ozone gas to the ozonated water generator, activating a drive source to rotate a centrifugal ozone gas and liquid contact device in the ozonated water generator, causing water to contact ozone gas in the ozonated water generator for generating ozonated water, and withdrawing ozonated water from the ozonated water generator. The invention can provide a high contacting area and low mass transfer resistance between ozone gas and water, thereby facilitating the dissolution of ozone gas in water.

### BACKGROUND OF THE INVENTION

1. Field of Invention

The present invention relates to ozonated water generation and more particularly to a method of generating ozonated water by employing centrifugal means and other improved means and a system thereof.

2. Description of Related Art

Ozone and/or fluid mixtures including ozone are widely used to remove various contaminants due to its excellent oxidative activity. Also, ozone is useful for eliminating the growth of microorganisms. Moreover, ozone is useful for sterilization, odor control purposes, and drinking water filtering. Known ozonated water generation methods by employing mechanical means do not involve warm-up time for evaporating residues as compared with known sterilization methods involving chlorination. Thus, the former methods are advantageous for effective treatment of metal particulates in water. Most known ozonated water generation methods involve steps of electrolysis of water for generating ozone, and mixing ozone in water for generating ozonated water. Hence, water and ozone mixture means is critical to ozonated water generation.

In addition, ozonated water finds utility in semiconductor industry for cleaning and surface conditioning in-process silicon wafers, liquid crystal glass substrates, quartz substrates for shielding light, etc. Further, wet cleaning. is widely employed for improving product quality. For eliminating organic or metal contaminants, strong oxidizing chemicals including SPM solution (i.e., a mixture of sulfuric acid and hydrogen peroxide) and SC2 solution (i.e., a mixture of hydrochloric acid, hydrogen dioxide, and pure water) are employed in cleaning. Recently, ozone is gradually employed in wet cleaning.

Known ozone generation methods including photochemical methods employed in generating small amount of ozone, electrical discharge, similar to electric shock, requiring high humidity, and plasma discharge involved impinging high energy electrons onto inert gas contained in a vacuum tube for generating ozone. Generated ozone is required to have a sufficient amount for applications of eliminating contaminants and sterilization. For cleaning silicon wafers or substrates, ozone gas is required to dissolve in pure water. Low ozone concentration (e.g., in the range of 1 ppm to several ppm) is typically required in traditional industry and high ozone concentration (e.g., several tens ppm) of stable supply is typically required in cleaning wafers in semiconductor industry or the like. Thus, how to increase ozone gas dissolved in water is critical for generating quality cleaning solution including ozone. There are a number of factors affecting the degree of ozone gas dissolved in water and they are ozone gas concentration, solution temperature, acid value, etc.

There have been numerous suggestions in prior patents about ozonated water generation. For example, U.S. Pat. No. 5,971,368 discloses a pressurized vessel for increasing the degree of ozone dissolved in water. U.S. Pat. No. 6,808,637 discloses a pipeline reactor for dissolving O3. However, both patents fail to quickly generate a solution with equilibrium concentration. Both prior patents are characterized in increasing period of contact between ozone and water and providing optimum operating temperature and pressure so as to increase ozonated water concentration and ozonated water generation rate. However, both patents improve little. Also, as far as the present inventor is aware, low ozone concentration (e.g., several ppm) or low flow rate (e.g., several liters per hour) is the subject of most present applications and this is the bottleneck of the current ozonated water generation methods.

Another drawback of prior patents is that there is no information about ozone concentrations in different regions when ozone gas is used to clean and surface condition silicon wafers. In this application, ozone of high concentration is dispersed into small bubbles by a dispersing machine and the bubbles are adapted to increase contact between ozone and liquid. However, bubbles are poor media when dissolved in water. Thus, ozonated water of high concentration is not easy to generate. Ozone may consume quickly when wafers are submerged in a cleaning chamber. Further, ozone may be insufficient when wafer cleaning is approaching its end. A prolonged period of cleaning time is required and thus yield is low. Oxidative activity of ozone may be enhanced by illuminating UV light thereonto as disclosed in recent improvements. However, this is still limited. For sterilization and sewage treatment applications, the consumption of ozonated water is even quick, resulting in a quick decrease of ozone concentration and thus a significant growth of microorganisms.

Moreover, U.S. Pat. No. 5,686,051 discloses an ozone water production apparatus capable of obtaining ozone water having a high concentration by a water electrolytic process using a noble metal electrode. Anode electrode and cathode electrode are put on opposite surfaces of a solid electrolytic film. Water supplied to the anode electrode is subjected to electrolysis to obtain ozone water. A wire net made of noble metal is used as the anode electrode, and a lath net made of corrosion resistant metal is put on the outer surface of the anode electrode. The anode electrode and the lath net are sealed into a jacket having a water inlet on one end and an ozone water outlet on the other end thereof.

U.S. Pat. No. 5,951,921 discloses an apparatus for producing ozone water by accelerated mixing and dissolving of ozone into water due to an enhanced contact efficiency of ozone gas and water includes a circulation line for circulating ozone water and employs a jet nozzle in a conduit which returns ozone water into a primary container. This causes negative pressure about the outlet of the nozzle, whereby the ozone gas is sucked into water which is jetted. Thus, ozone gas is rapidly mixed and dissolved into water.

U.S. Pat. No. 6,076,808 discloses an apparatus for producing ozonated water. A pump siphons ozonated water from chamber of a container via outlet thereof. An introducing assembly is provided for introducing vaporized ozone into the chamber through a second inlet. A sensor measures oxygen reduction potential of ozonated water, and controls amount of vaporized ozone introduced into the chamber by the introducing assembly.

U.S. Pat. No. 6,808,637 discloses a system for producing ozone water and control method thereof for reconstituting polluted water as environmentally friendly. The system is maintained in an optimum state for improving entire performance and predicting and preventing backflow of ozone water, which is occurred due to outlet blocking in a discharging process. The control method enables to prevent deteriorating the performance and ensure the operation stability. The invention is designed to prevent water backflow, being frequently occurred in the conventional system.

Thus, it is desirable to constantly seek continuing improvements in the exploitation of ozonated water generation in order to overcome the inadequacies of the prior art.

### SUMMARY OF THE INVENTION

It is therefore an object of the present invention to provide a method of generating ozonated water and a system thereof by employing a centrifugal ozone gas and liquid contact device for providing a relatively high contacting area and low mass transfer resistance between ozone gas and water, thereby facilitating the dissolution of ozone gas in water.

In one aspect of the present invention, there is provided a system of generating ozonated water comprising a centrifugal ozonated water generator for facilitating ozone gas dissolved in water so as to generate ozonated water of high concentration; a centrifugal drive source for rotating the ozonated water generator; a liquid source for supplying water to the ozonated water generator via a first conduit; an ozone gas generator fluidly connected to the ozonated water generator via a second conduit for supplying generated ozone gas thereto; an ozonated water drain regulator mounted in the ozonated water generator for regulating the drain of ozonated water; and a sensing assembly for monitoring ozone gas concentration and ozonated water concentration in the ozonated water generator, comparing monitor data with a predetermined value and controllably adjusting same in response to the comparison, and automatically controlling a rotation speed of the drive source in response to a speed change signal.

In another aspect of the present invention, the ozonated water generator comprises a housing served as a vessel of mixing ozone gas with water; a centrifugal ozone gas and liquid contact device mounted in the housing and including a rotatable cylinder and a media for facilitating contact between ozone gas and water; first and second airtight units sealingly provided on a top and a bottom of the centrifugal ozone gas and liquid contact device respectively; a water inlet for permitting water introduced from the liquid source to flow therethrough; a spray provided in the centrifugal ozone gas and liquid contact device and being in fluid communication with the water inlet, the spray being adapted to shoot out the introduced water as a jet of fine liquid particles (or even slim water curtain); an ozone inlet fluidly connected to the ozone gas generator for receiving ozone gas therefrom; an ozone disperser fluidly connected to the ozone inlet and provided in the housing for uniformly dispersing introduced ozone gas toward the cylinder of the centrifugal ozone gas and liquid contact device; an ozonated water outlet fluidly connected to the external for flowing ozonated water thereto; and an ozone outlet fluidly connected to the cylinder of the centrifugal ozone gas and liquid contact device for discharging remaining ozone gas.

In yet another aspect of the present invention, the sensing assembly comprises an ozone gas concentration sensor for monitoring ozone gas concentration, an ozonated water concentration sensor for monitoring liquid ozone concentration, and a feedback unit adapted to compare data input from both the ozone gas concentration sensor and the ozonated water concentration sensor with a predetermined value and controllably adjust ozone gas from the ozone gas generator and water from the liquid source in response to the comparison.

In a further aspect of the present invention, further comprises a governor adapted to automatically control the rotation speed of the drive source for adjusting centrifugal force of the centrifugal ozone gas and liquid contact device in response to a speed change signal fed from the sensing assembly.

In a still further aspect of the present invention, further comprises a filter for removing particulates from drain ozonated water and supplying filter ozonated water to the centrifugal ozone gas and liquid contact device for recycling.

In a yet further aspect of the present invention, in a system including a centrifugal ozonated water generator, a centrifugal drive source for rotating the ozonated water generator, a liquid source for supplying water to the ozonated water generator, an ozone gas generator fluidly connected to the ozonated water generator, an ozonated water drain regulator, and a sensing assembly for monitoring ozone gas concentration, there is provided a method of generating ozonated water comprising supplying water to an ozonated water generator; supplying ozone gas to the ozonated water generator; activating a drive source to rotate a centrifugal ozone gas and liquid contact device in the ozonated water generator; causing water to contact ozone gas in the ozonated water generator for generating ozonated water; and withdrawing ozonated water from the ozonated water generator through an ozonated water outlet of the ozonated water generator.

The above and other objects, features and advantages of the present invention will become apparent from the following detailed description taken with the accompanying drawings.

### BRIEF DESCRIPTION OF THE DRAWINGS

FIG. 1 is a block diagram of a preferred embodiment of ozonated water generation system according to the invention;

FIG. 2 is a cross-sectional view of ozonated water generator of FIG. 1;

FIG. 3 is a cross-sectional view of centrifugal ozone gas and liquid contact device of FIG. 1;

FIG. 4 is a cross-sectional view of the centrifugal ozone gas and liquid contact device taken along line 4-4 of FIG. 3;

FIG. 5 is a block diagram of sensing assembly and other associated components of FIG. 1;

FIG. 6 is a block diagram showing flow of the ozonated water generation system of the invention; and

FIG. 7 plots liquid ozone concentration versus ozonated water dispense time for various ozone gas concentrations.

### DETAILED DESCRIPTION OF THE INVENTION

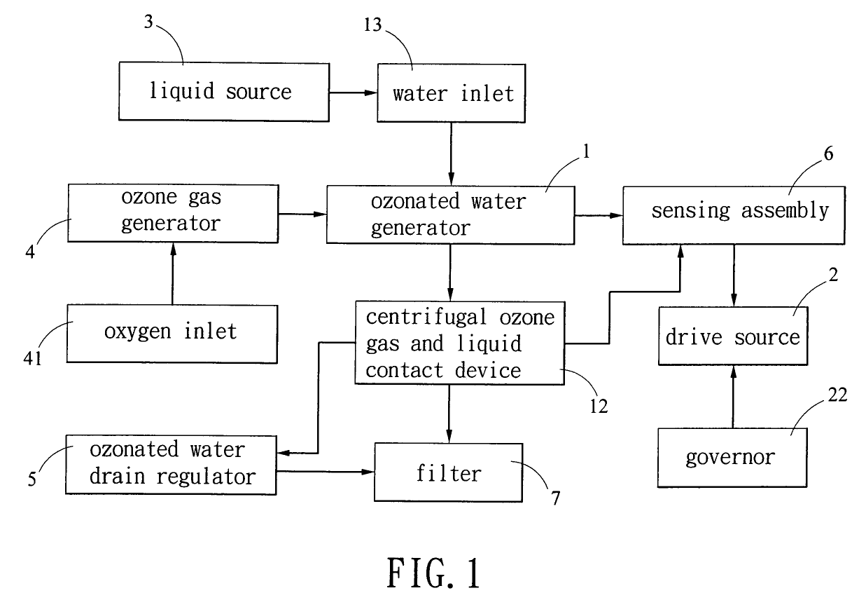

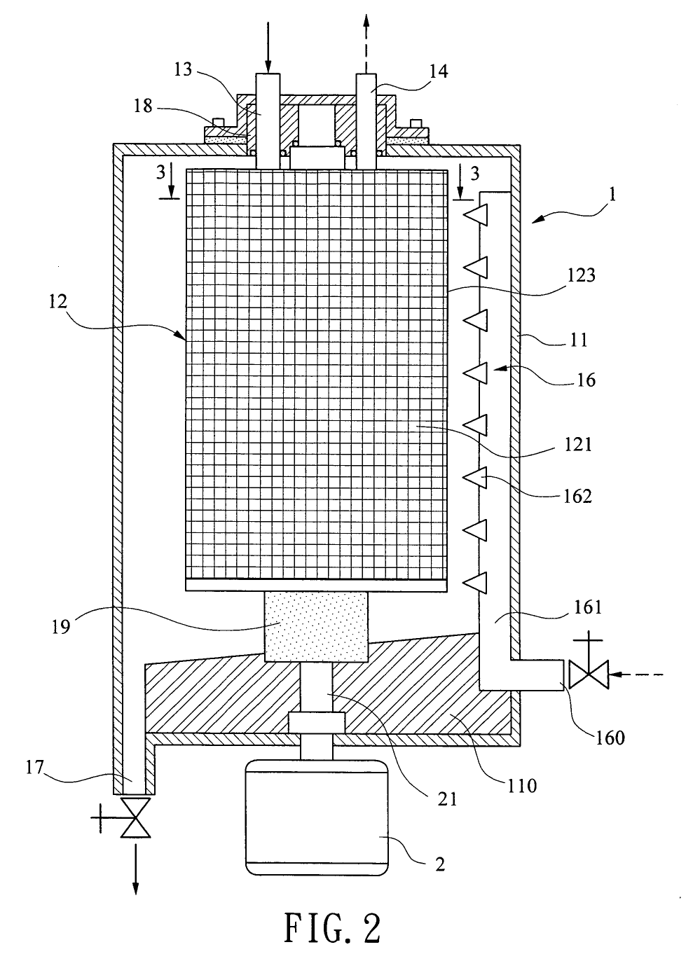

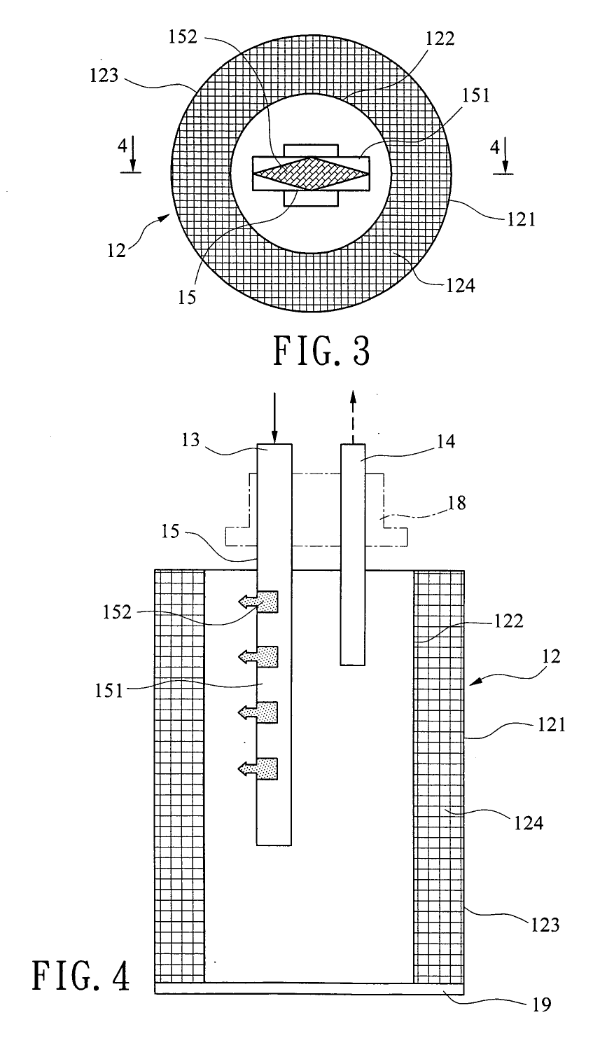

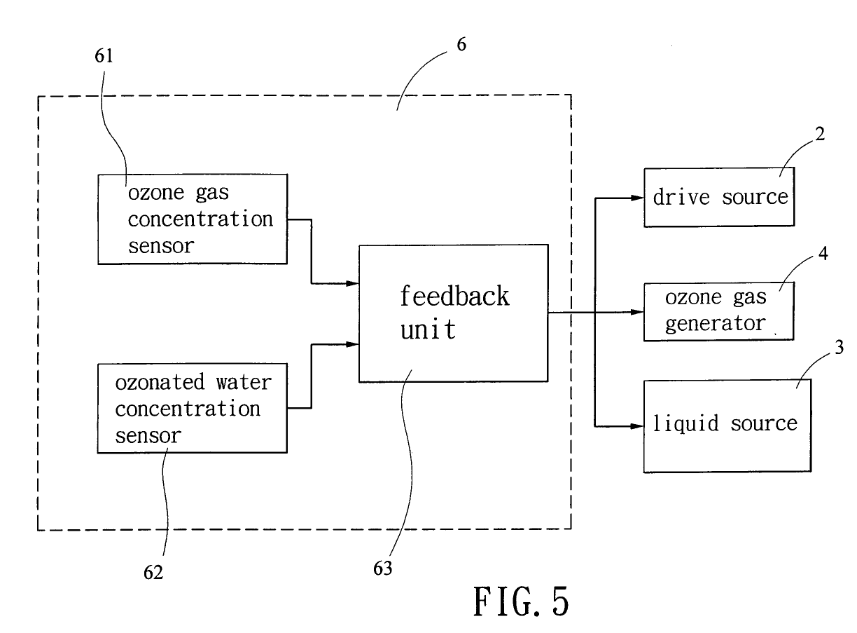

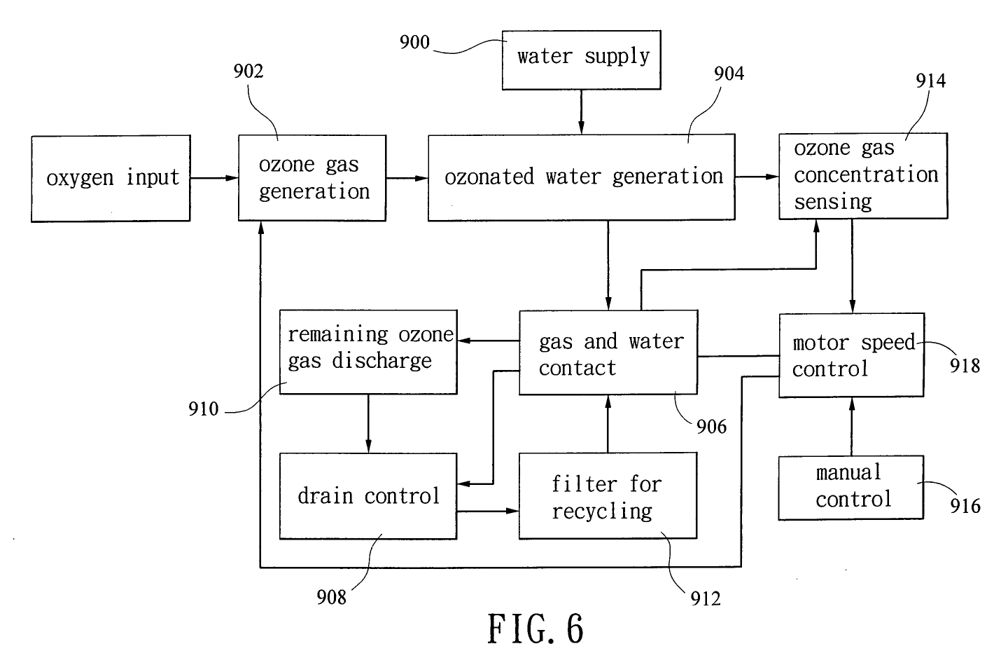

Referring to FIGS. 1 to 5, an ozonated water generation system in accordance with a preferred embodiment of the invention comprises an ozonated water generator 1 for providing a mechanism of facilitating ozone gas dissolved in water so as to generate ozonated water of high concentration; a drive source 2 for activating the ozonated water generator 1 to generate strong centrifugal force; a liquid source 3 for supplying water; an ozone gas generator 4; an ozonated water drain regulator 5; a sensing assembly 6 for monitoring ozone gas concentration and automatically adjusting same; and a filter 7 for removing particulates from ozonated water prior to supplying to a centrifugal ozone gas and liquid contact device 12 (see FIG. 6). Each component is discussed in detailed below.

The ozonated water generator 1 comprises a high speed rotation device provided in its airtight chamber, the rotation device being operative to break supply water into droplets or atomize and then turn the droplets into very thin water film on the porous-packing in the rotation device same by utilizing generated centrifugal force. Water films are then absorbing ozone molecules in the gas phase rapidly for generating ozonated water of high concentration.

The ozonated water generator 1 comprises the following components. A housing 11 serves as a vessel of mixing ozone gas with water and thus a container of storing generated ozonated water (as buffer tank). Preferably, the housing 11 is highly resistant to corrosive chemicals. A centrifugal ozone gas and liquid contact device 12 is mounted in the housing 11 by means of airtight units 18 and 19. A water inlet 13 and an ozone outlet 14 are provided on top of the housing 11. A spray 15 is provided in the centrifugal ozone gas and liquid contact device 12 and comprises a conduit 151 in fluid communication with the water inlet 13, and a plurality of nozzles 152 provided along surface of the conduit 151 for spraying water into the centrifugal ozone gas and liquid contact device 12. An ozone disperser 16 is provided on an inner surface of the housing 11 and comprises a conduit 161 having an opening 160 as ozone inlet for receiving ozone gas from the ozone gas generator 4. Input ozone gas is then uniformly dispersed in the housing 11 through a plurality of nozzles 162 along surface of the conduit 161. An ozonated water outlet 17 is provided at a bottom of the housing 11 for exiting ozonated water of high concentration generated by the centrifugal ozone gas and liquid contact device 12. Other components of the ozonated water generator 1 such as water inlet, water outlet, ozone inlet, ozone outlet, ozone bypass, ozone gas analyzer, flow regulator, or the like are well known in the art. Accordingly, further description is omitted for purposes of brevity and convenience only, and is not limiting.

The centrifugal ozone gas and liquid contact device 12 comprises a hollow cylinder 121 of porous construction formed of porous metal material or porous non-metal material. The cylinder 121 has an inner surface 122 and an outer surface 123. A media 124 is provided between the inner surface 122 and the outer surface 123. The media 124 is formed of porous material such as metal balls, stainless steel meshes, glass balls, ceramic members, metal oxide, or the like. The media 124 is adapted to cause gas to contact with water.

A member 110 is provided on bottom of the housing 11. The member 110 has a top surface inclined toward the ozonated water outlet 17 for directing ozonated water thereto.

Each of the airtight units 18 and 19 has bearings along its central shaft and is provided on either top or bottom of the centrifugal ozone gas and liquid contact device 12 as support and airtight means. The airtight units 18 and 19 are adapted to decrease rate of ozone gas leaking the centrifugal ozone gas and liquid contact device 12.

The drive source 2 is implemented as a motor and is connected to the centrifugal ozone gas and liquid contact device 12 through the bottom airtight unit 19 by means of its driving shaft 21. Hence, the drive source 2 may activate to rotate the centrifugal ozone gas and liquid contact device 12. The drive source 2 further comprises a governor 22. The governor 22 is adapted to automatically control speed of the drive source 2 in response to a speed change signal fed from the sensing assembly 6. As an end, both speed of the operating centrifugal ozone gas and liquid contact device 12 and centrifugal force thus generated can be controllably adjusted.

The liquid source 3 is in fluid communication with the water inlet 13 for supplying water to the centrifugal ozone gas and liquid contact device 12. The water may be tap water, filtered water, or pure water.

The ozone gas generator 4 comprises an oxygen inlet 41 at one end and an ozone gas outlet at the other end in fluid communication with the ozone inlet 160 for supplying ozone gas to be dissolved in the centrifugal ozone gas and liquid contact device 12.

The sensing assembly 6 comprises an ozone gas concentration sensor (e.g., ozone gas analyzer) 61 for monitoring ozone gas concentration, an ozonated water concentration sensor (e.g., liquid ozone analyzer) 62 for monitoring liquid ozone concentration, and a feedback unit 63 adapted to compare data input from both the ozone gas concentration sensor 61 and the ozonated water concentration sensor 62 with a predetermined value and controllably adjust ozone gas from the ozone gas generator 4 and water from the liquid source 3 in response to the comparison.

Referring to FIG. 6 in conjunction with FIGS. 1 to 5, a method of centrifugally generating ozonated water in accordance with the invention is illustrated. In step 900, water is introduced from the liquid source 3 into the ozonated water generator 1 via the water inlet 13. In step 902, the ozone gas generator 4 activates to introduce ozone gas to the ozonated water generator 1 via the ozone inlet 160. In step 904, both ozone gas and water are introduced in the centrifugal ozone gas and liquid contact device 12. In step 906, the nozzles 152 in the centrifugal ozone gas and liquid contact device 12 operate to spray water to the cylinder 121 being rotated in high speed due to activation of the drive source 2. Water is broken into droplets or atomized and then turned into very thin water film in the surface of porous construction of the centrifugal ozone gas and liquid contact device 12 due to strong centrifugal force of the centrifugal ozone gas and liquid contact device 12. Water films then permeate the inner surface 122, the media 124, and the outer surface 123, and the leaving water film from centrifugal ozone gas and liquid contact device 12 become fine droplets to impinge the housing 11. Also, ozone gas introduced from the ozone inlet 160 is sent to the nozzles 162 prior to spraying toward inside of the centrifugal ozone gas and liquid contact device 12. Thus, ozone gas and water are in contact each other in the centrifugal ozone gas and liquid contact device 12. The high speed rotation of the centrifugal ozone gas and liquid contact device 12 can provide a relatively high contacting area and low mass transfer resistance between ozone gas and water, thereby facilitating the dissolution of ozone gas in water and shortening time required to reach an equilibrium of liquid ozone concentration. In step 908, ozonated water of high concentration then leaves the ozonated water outlet 17 via the ozonated water drain regulator 5. In step 910, remaining ozone gas disposed internally of the housing 11 leaves the ozonated water generator 1 via the ozone outlet 14. In step 912, drained liquid may flow to the filter 7 to remove particulates prior to feeding to the centrifugal ozone gas and liquid contact device 12 for recycling.

In step 914, the sensing assembly 6 monitors ozone concentration and ozonated water concentration in the ozonated water generator 1. The feedback unit 63 is adapted to compare data input from both the ozone gas concentration sensor 61 and the ozonated water concentration sensor 62 with a predetermined value and controllably adjust ozone gas from the ozone gas generator 4 and water from the liquid source 3 in response to the comparison. Alternatively, a manual control is effected as a replacement of the feedback unit 63 in step 916. The governor 22 is adapted to automatically control speed of the drive source 2 and thus control the amount of generated ozone gas in the ozone gas generator 4. Also, the governor 22 is adapted to automatically control speed of the drive source 2 for adjusting centrifugal force of the centrifugal ozone gas and liquid contact device 12 in response to a speed change signal fed from the sensing assembly 6. As an end, ozonated water with desired concentration is generated.

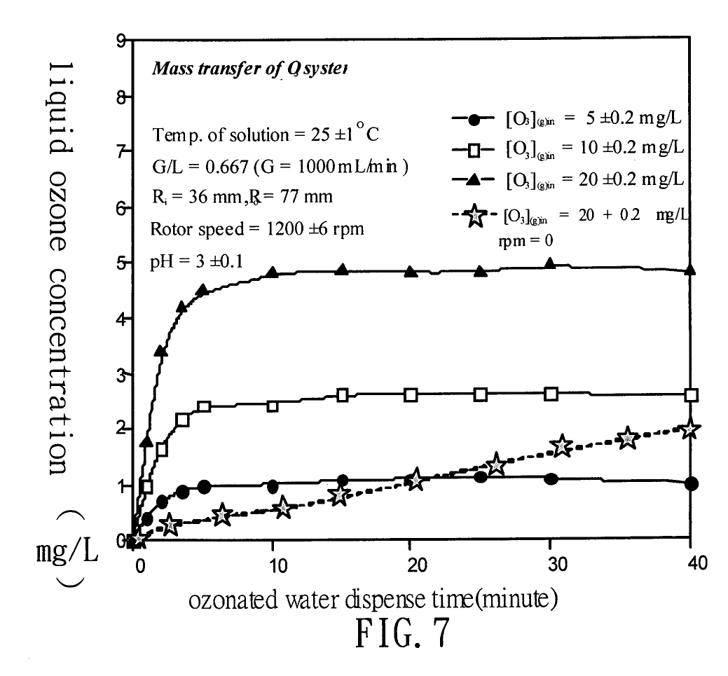

Referring to FIG. 7, it plots liquid ozone concentration versus ozonated water dispense time for various ozone gas concentrations based on an experiment preparing ozonated water for cleaning semiconductor wafers or TFTs. It is found that liquid ozone concentration increases most and time required to reach a saturated concentration of liquid ozone is shortest when rotor speed is 1200 rpm and ozone gas concentration is 20 mg/L. Saturated concentration of liquid ozone decreases as ozone gas concentration decreases but time required to reach a saturated concentration of liquid ozone is substantially the same. It is thus concluded that time required to reach a saturated concentration of liquid ozone is not affected by concentration of input ozone gas. Further, 38% of saturated concentration of liquid ozone is reached in 40 minutes when ozone gas concentration is 20 mg/L and the system of the invention is inoperative. In other words, the centrifugal system of the invention can greatly increase the ability of mass transfer for ozone gas dissolved in water.

While the invention herein disclosed has been described by means of specific embodiments, numerous modifications and variations could be made thereto by those skilled in the art without departing from the scope and spirit of the invention set forth in the claims.

What is claimed is:

1. A system of generating ozonated water comprising:
a centrifugal ozonated water generator for facilitating ozone gas dissolved in water so as to generate ozonated water of high concentration;
a centrifugal drive source for rotating the ozonated water generator;
a liquid source for supplying water to the ozonated water generator via a first conduit;
an ozone gas generator fluidly connected to the ozonated water generator via a second conduit for supplying generated ozone gas thereto;
an ozonated water drain regulator mounted in the ozonated water generator for regulating the drain of ozonated water; and
a sensing assembly for monitoring ozone gas concentration and ozonated water concentration in the ozonated water generator, comparing monitor data with a predetermined value and controllably adjusting same in response to the comparison, and automatically controlling a rotation speed of the drive source in response to a speed change signal.

2. The system of claim 1, wherein the ozonated water generator comprises:
a housing served as a vessel of mixing ozone gas with water;
a centrifugal ozone gas and liquid contact device mounted in the housing and including a rotatable cylinder and a media for facilitating contact between ozone gas and water;
first and second airtight units sealingly provided on a top and a bottom of the centrifugal ozone gas and liquid contact device respectively;
a water inlet for permitting water introduced from the liquid source to flow therethrough;
a spray provided in the centrifugal ozone gas and liquid contact device and being in fluid communication with the water inlet, the spray being adapted to shoot out the introduced water as a jet of fine liquid particles or slim water curtain;
an ozone inlet fluidly connected to the ozone gas generator for receiving ozone gas therefrom;
an ozone disperser fluidly connected to the ozone inlet and provided in the housing for uniformly dispersing introduced ozone gas toward the cylinder of the centrifugal ozone gas and liquid contact device;
an ozonated water outlet fluidly connected to the external for flowing ozonated water thereto; and
an ozone outlet fluidly connected to the cylinder of the centrifugal ozone gas and liquid contact device for discharging remaining ozone gas.

3. The system of claim 2, wherein the cylinder of the centrifugal ozone gas and liquid contact device is a hollow porous construction formed of a porous metal material or a porous non-metal material between its inner surface and its outer surface.

4. The system of claim 2, wherein the media is formed of a porous material selected from metal balls, stainless steel meshes, glass balls, ceramic members, or metal oxide, and wherein the media is adapted to cause ozone gas to contact with water.

5. The system of claim 2, wherein the spray comprises a third conduit in fluid communication with the water inlet, and a plurality of nozzles provided along a surface of the third conduit.

6. The system of claim 2, wherein the ozone disperser is provided on an inner surface of the housing.

7. The system of claim 2, wherein the ozone disperser comprises a fourth conduit fluidly connected to the ozone gas generator via the ozone inlet, and a plurality of nozzles provided along a surface of the fourth conduit.

8. The system of claim 2, wherein each of the airtight units comprises a central shaft and bearings sealingly provided along the shaft.

9. The system of claim 1, wherein the drive source is a motor connected to the centrifugal ozone gas and liquid contact device by means of its driving shaft, and wherein the drive source is operative to rotate the centrifugal ozone gas and liquid contact device.

10. The system of claim 1, further comprising a governor adapted to automatically control the rotation speed of the drive source for adjusting centrifugal force of the centrifugal ozone gas and liquid contact device in response to a speed change signal fed from the sensing assembly.

11. The system of claim 1, wherein water supplied by the liquid source is tap water, filtered water, or pure water.

12. The system of claim 1, wherein the sensing assembly comprises an ozone gas concentration sensor for monitoring ozone gas concentration, an ozonated water concentration sensor for monitoring liquid ozone concentration, and a feedback unit adapted to compare data input from both the ozone gas concentration sensor and the ozonated water concentration sensor with a predetermined value and controllably adjust ozone gas from the ozone gas generator and water from the liquid source in response to the comparison.

13. The system of claim 12, wherein the ozone gas concentration sensor is an ozone gas analyzer and the ozonated water concentration sensor is a liquid ozone analyzer.

14. The system of claim 1, further comprising a filter for removing particulates from drain ozonated water and supplying filter ozonated water to the centrifugal ozone gas and liquid contact device for recycling.

15. A system of generating ozonated water comprising:
a centrifugal ozonated water generator for facilitating ozone gas dissolved in water so as to generate ozonated water of high concentration;
a centrifugal drive source for rotating the ozonated water generator; and
a sensing assembly for monitoring ozone gas concentration and ozonated water concentration in the ozonated water generator, comparing monitor data with a predetermined value and controllably adjusting same in response to the comparison, and automatically controlling the speed of the drive source in response to a speed change signal.

16. The system of claim 15, further comprising a liquid source for supplying water to the ozonated water generator via a first conduit, and an ozone gas generator fluidly connected to the ozonated water generator via a second conduit for supplying generated ozone gas thereto.

17. In a system including a centrifugal ozonated water generator, a centrifugal drive source for rotating the ozonated water generator, a liquid source for supplying water to the ozonated water generator, an ozone gas generator fluidly connected to the ozonated water generator, an ozonated water drain regulator, and a sensing assembly for monitoring ozone gas concentration, a method of generating ozonated water comprising the steps of:
(a) supplying water to an ozonated water generator;
(b) supplying ozone gas to the ozonated water generator;
(c) activating a drive source to rotate a centrifugal ozone gas and liquid contact device in the ozonated water generator;
(d) causing water to contact ozone gas in the ozonated water generator for generating ozonated water; and
(e) withdrawing ozonated water from the ozonated water generator through an ozonated water outlet of the ozonated water generator.

18. The method of claim 17, wherein in the step (d) further comprises sub-steps of (d1) causing a sensing assembly to compare ozone gas concentration with a predetermined value, and controllably adjusting ozone gas from the ozone gas generator and water from the liquid source in response to the comparison.

19. The method of claim 17, wherein ozonated water concentration depends on an amount of water from the liquid source, an amount ozone gas from the ozone gas generator, and a rotation speed of the centrifugal ozone gas and liquid contact device.

20. The method of claim 17, wherein in the step (d) further comprises sub-steps of (d2) causing the centrifugal ozone gas and liquid contact device to break water into droplets, further then turned into very thin water film, and causing the water films to contact ozone gas flowed in an opposite direction for generating ozonated water in the ozonated water generator.
